(19) United States
(12) Patent Application Publication
(10) Pub. No.: US 2017/0252250 A1
(43) Pub. Date: Sep. 7, 2017

(54) ACTIVE HEAD-SHOULDER AND TORSO POSITIONING DEVICE FOR ENDOTRACHEAL INTUBATION

(71) Applicant: Patient Positioning Systems, LLC, Annapolis, MD (US)

(72) Inventors: Daniel S. GABBAY, Alexandria, VA (US); Cynthia M. MILLER, Sandy Hook, CT (US); Carmine CAPARASO, Monroe, CT (US)

(21) Appl. No.: 15/059,264

(22) Filed: Mar. 2, 2016

(51) Int. Cl. A61G 13/12

(52) U.S. Cl. CPC A61G 13/1265; A61G 13/121; A61G 13/1255; A61G 13/122; A61G 2203/14

(57) ABSTRACT

An improved active head/shoulder and neck positioning device for positioning a patient undergoing endotracheal intubation, including: (1) a horseshoe-shaped torso support bladder adapted to be positioned underneath the torso of a patient that provides added stability, (2) a head support bladder affixed to a top surface of the torso support bladder, (3) at least one source of compressed air, and (4) a combined joystick/controller for selectively conducting pressurized air from the source to the torso support bladder and the head support bladder. The torso support bladder expands as it is inflated and it can be vented to an atmosphere for deflation. The head support bladder is positioned for placement beneath the patient's head, and it is operative to elevate the patient's head as the head support bladder is inflated and the headrest thereby expands. The at least one source of compressed air is in fluid communication with the torso support bladder and the head support bladder. The combined joystick/controller can be used to achieve optimal anatomical alignment of the patient's larynx for intubation.

### FIELD OF THE INVENTION

The present invention generally relates to an improved head/shoulder and torso positioning device for facilitating endotracheal intubation. More specifically, it relates to an active laryngoscopist-controlled adjustable head/shoulder and torso positioning device for efficiently achieving the proper intubation. The present invention also provides an improved view of the laryngeal anatomy which improves the work of breathing and prolongs the safe apnea period position.

### BACKGROUND OF THE INVENTION

Patient treatment in the medical arts often requires endotracheal intubation. Although newer technologies have emerged to visualize laryngeal anatomy in real time, direct laryngoscopy is still the mainstay of tracheal cannulation. Proper positioning remains paramount.

Direct laryngoscopy (DL) is the direct visualization of the larynx (by displacing the tongue and epiglottis) using a rigid laryngoscope. Despite the advent of video laryngoscopy, DL remains the primary means of achieving endotracheal intubation. While proper patient positioning has long been recognized as being integral to successful cannulation of the trachea, this practice is often overlooked by laryngoscopists, particularly in the emergency setting. Improper patient positioning is thought to be a cause of failed intubation in the difficult airway and attempts to obviate poor laryngeal view using static devices that cannot be customized or stacks of hospital linen which are cumbersome to employ, makes endotracheal intubation potentially fraught with peril. A difficult or failed intubation can result in death, brain injury, airway trauma, tracheal or esophageal perforation, pneumothorax and aspiration. Manual attempts to obviate poor laryngeal view by manipulating patient position are nonstandard, unreliable and extremely time inefficient.

Successful endotracheal intubation using direct laryngoscopy is contingent upon alignment of the oral, pharyngeal and laryngeal axes in what is called the “sniffing position.” In this position, the patient's head is slightly extended and the occiput is elevated approximately 7 cm. Often, positioning the patient in this manner is enough to obtain a reasonable percentage of glottic opening (POGO) score that allows identification of the usual laryngeal landmarks.

However, laryngeal exposure can be limited due to a multiplicity of factors. Distortion (trauma, infection, neo-plasm, edema etc.), disproportion (tongue/pharynx) or body habitus (particularly obese patients), can all compromise landmark recognition and make the sniffing position suboptimal or even inadequate. The laryngoscopist can sometimes compensate for limited laryngeal exposure by lifting the patient's head off of the bed with the laryngoscope. The human head weighs 8 to 10 lbs. and, in obese patients, such lifting of the head and shoulders may be impossible. However, the medical literature has shown that laryngeal exposure can be improved with less required force by increasing head elevation and neck flexion. Without a mechanical device to enable this, massive amounts of support must be placed under the head, neck and shoulders.

In order to achieve proper body positioning for endotracheal intubations, body support devices have been created. For example, U.S. Pat. No. 4,259,757 issued to Watson entitled “Support Cushion” discloses a cushion for medical use to support a patient's head and neck that can be utilized to achieve the sniffing position of the patient's head and torso to facilitate endotracheal intubations. However, the cushion is for support of the head only and cannot provide any support for the patient's shoulders or torso which is desired for a full support system to achieve the sniffing position of the patient.

U.S. Pat. No. 5,048,136 discloses an infant support for airway management which aligns the oropharyngeal, laryngeal and tracheal axes of an infant. This support is in the form of a cushion with cut-outs which receive the head and torso of the infant. However, this mat is not adjustable in any way.

Other, adjustable head and torso supports are known for example as shown in U.S. Pat. No. 5,528,783 issued to Kunz et al. That patent discloses an inflatable head and torso support which is adjustable by the user whereby an air bladder can be fully inflated, partially inflated, or fully deflated as desired by the user to incline the head or the head and torso. Inflation is controlled by valves that are in turn actuated by switches located on the edge of a sheet of material positioned under the torso of the user and attached to the support. The support is wedge-shaped and contains only one bladder. Therefore, it is incapable of individually elevating the head and torso portions of the user's body independently and therefore would not be appropriate as an ideal tracheal intubation body positioning support.

U.S. Pat. No. 7,127,758 to Gabbay discloses a pneumatically controlled intubation mat that includes laryngoscope-mounted controls. The '758 Patent discloses a body supporting mat that is positioned beneath the patient undergoing endotracheal intubation that is dimensioned to extend beneath the patient's torso and head while in a substantially upward-facing prone position. The '758 Patent discloses an inflatable bladder that is positioned between a base and a mat board which is adapted to elevate the mat board with respect to the base as the bladder is inflated and thereby expands. An expandable headrest is affixed to a top surface of the mat board and is positioned for placement beneath the patient's head. The headrest further includes a head support air bladder which is operative to elevate the patient's head as the head support bladder is inflated and the headrest thereby expands. In the '758 Patent, a source of compressed air is in fluid communication with the torso support bladder and the head support bladder by way of an air distribution manifold. The valve means on the air distribution manifold selectively conducts pressurized air from the source to the torso support bladder and the head support bladder whereby the patient's torso/head position may be altered to achieve optimal anatomical alignment of the patient's larynx for intubation. The valve means disclosed in the '758 Patent, are preferably electro mechanical valves which are actuated by thumb switches located on a housing which is snap-fit to the top of the intubation handle.

U.S. Pat. No. 7,383,599 to Gabbay is directed to a body support for positioning beneath a patient undergoing endotracheal intubation which is dimensioned to extend beneath the patient's torso and head while in a substantially upward-facing prone position. An inflatable bladder is adapted to elevate the patient as the bladder is inflated and thereby expands. An expandable headrest is positioned for placement beneath the patient's head. The headrest further includes a head support air bladder which is operative to elevate the patient's head as the head support bladder is inflatable and the headrest expands. A source of compressed air is in selectable fluid communication by way of valve means with the torso support bladder whereby the patient's torso/head position may be altered to achieve optimal anatomical alignment of the patient's larynx for intubation. The valve means are preferably electromechanical valves which are actuated by thumb switches located on a housing which is snap fit to the top of the intubation handle.

There is therefore a need in the art for an improved patient positioning system that allows the patient's body and head position to more easily be changed and controlled as needed in order to achieve the best possible position for endotracheal intubation and which operates more efficiently. In addition, there is also a need to ensure the position of the patient is stabilized during inflation and deflation. Patient stability is necessary to ensure any existing injuries are not worsened, and to ensure the patient remains securely on the table.

### SUMMARY OF THE INVENTION

In order to simplify and improve the prior practice of endotracheal intubation body positioning, the present invention has been devised. Should a difficult airway be encountered and the usual laryngeal landmarks cannot be visualized, the device may be placed underneath a patient in an unobtrusive manner ready to be utilized. Toward this end, the invention includes two inflatable bladders, a head support bladder and a torso support bladder, which are independently inflatable. Included within the torso support bladder is a “horseshoe shaped” component which helps cradle and stabilize the patient's torso in an optimal, or near-optimal position, for endotracheal intubation. As one of ordinary skill in the art would appreciate, the cradling effect accomplished through the use of a horseshoe shaped component may also be accomplished through the use of structurally similar devices. The horseshoe shaped component (or comparable structures) provides greater stability and patient comfort. In addition, the individual controls, or valve means of previous inventions, have been combined into a single, dual axis joystick/controller to inflate/deflate both chambers of the improved head positioning device for facilitating endotracheal intubation. For example, and without limitation, moving the joystick in a northerly direction may inflate the head support bladder, while moving the joystick in a southerly direction may deflate the head support bladder. Similarly, moving the joystick in an easterly direction, may inflate the torso support bladder, while moving the single joystick in a westerly direction may deflate the torso support bladder. The device may also be controlled in a similar fashion using a foot switch with two rocker pedals—each pedal controls inflation and deflation of its respective chamber allowing for hands free airway management and intubation.

Thus, the purpose of the invention is to simplify the safe and reliable positioning of the patient during both routine and difficult endotracheal intubations. It is therefore the primary object of the present invention to mechanically facilitate successful endotracheal intubation by permitting the proper adjustment of patient position when laryngeal exposure is poor. Other objects and advantages will become apparent to those of skill in the art from the following drawings and description of the various embodiments.

### DESCRIPTION OF THE DRAWINGS

FIG. 1 is a top left side isometric assembly view of the invention.

FIG. 2 illustrates another view of the improved active head/shoulder and torso positioning device 100 which provides a better view of the horseshoe-shaped component 140.

FIG. 3 is a top view of the inflatable head support bladder and the inflatable torso support bladder.

FIG. 4 is a front view of the dual axis joystick/controller module.

FIG. 5 is a schematic diagram of the circuitry for the joystick/controller module.

FIG. 6A illustrates the inflatable head support bladder and the inflatable torso support bladder fully deflated.

FIG. 6B illustrates the inflatable head support bladder and the inflatable torso support bladder in a partially inflated state.

FIG. 6C illustrates the inflatable head support bladder and the inflatable torso support bladder in a full inflated state.

FIGS. 7A-7C are left side elevation views of the present invention supporting a patient in three different positions.

FIGS. 8A and 8B are an example of other controller means, in this case a footswitch, that may be used with the present invention.

### DESCRIPTION OF THE PREFERRED EMBODIMENT

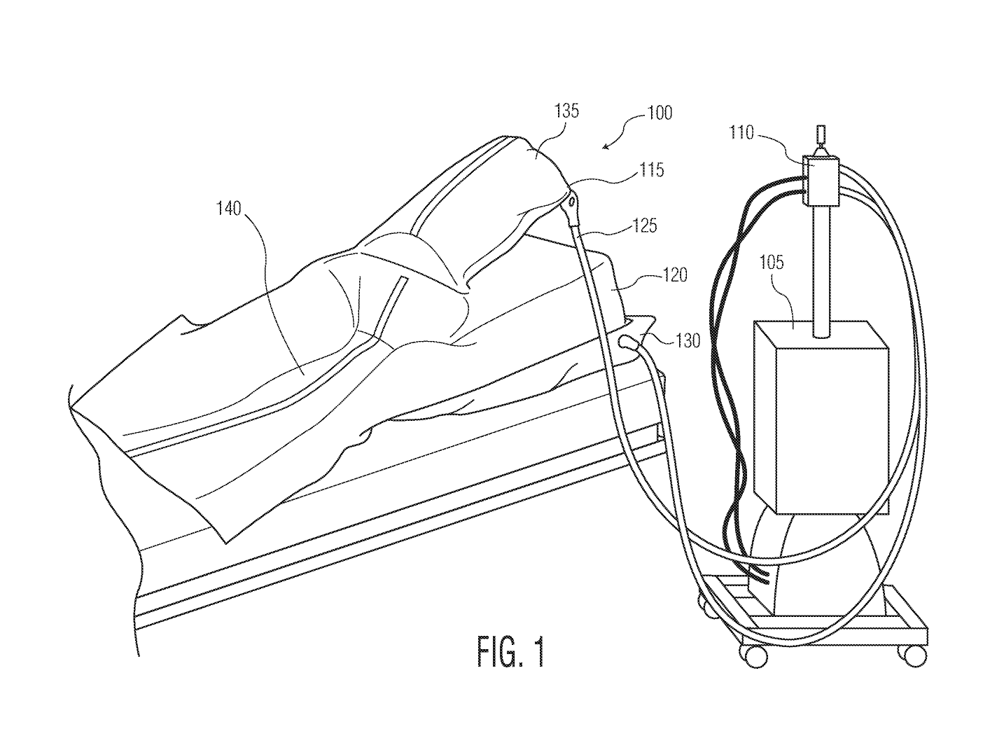

FIG. 1 illustrates the basic components of the improved active head/shoulder and torso positioning device 100 for endotracheal intubation including a compressor 105 which provides a source of compressed air, a combined joystick/controller module 110 for selectively delivering (or deflating) the compressed air to either the head support bladder 115 or the torso support bladder 120. One of ordinary skill in the art would appreciate that the source of compressed air could alternatively come from a compressed air system installed in the operating room or in other rooms used to support the operating room. Sources of compressed air which exceed the pressure required to inflate the head/shoulder and torso positioning device 100 may require the use of a pressure release value (or equivalent) to ensure that the pressure from the compressed air source is not transferred directly into the head/shoulder and torso positioning device 100. In one embodiment, moving the joystick in a northerly direction may inflate the head support bladder 115, while moving the joystick in a southerly direction may deflate the head support bladder 115. Similarly, moving the joystick in an easterly direction, may inflate the torso support bladder 120, while moving the single joystick in a westerly direction may deflate the torso support bladder 120. In an alternate embodiment, moving the joystick in a northerly direction may deflate the head support bladder 115, while moving the joystick in a southerly direction may inflate the head support bladder 115. Similarly, moving the joystick in an easterly direction, may deflate the torso support bladder 120, while moving the single joystick in a westerly direction may inflate the torso support bladder 120. Additionally, the functionality associated with the various joystick directions may be programmable such that the facility may decide which functionality (i.e., inflation of the head support bladder 115, deflation of the head support bladder 115, inflation of the torso support bladder 120, or deflation of the torso support bladder 120) are associated with the various joystick directions (movement in the upward direction, movement in the downward direction, movement to the left of the center position of the joystick, or movement to the right of the center position of the joystick). Alternatively, a foot pedal, such as a UL 60601 certified electric foot pedal may be used in addition to the joystick/controller, or in place of the joystick/controller. When a foot pedal is used, it preferably would connect to the joystick box identified herein.

Also shown in FIG. 1 are the head support bladder value 125 and the torso support bladder value 130. Preferably, head support bladder value 125 and torso support bladder value 130 are disposable plastic fitment that are heat sealed into the disposable device. Typically, a reusable plastic coupling is attached to the air tubing that connects to the fitment. As shown in FIG. 1, the head support bladder 115 is located horizontally in the middle of the torso support bladder 120. In addition, the head support bladder 115 includes a folded under portion 135 which ensures that the head support bladder 115 inflates to a specific shape when inflation occurs through use of the combined joystick/controller 110. Also shown in FIG. 1 is the horseshoe-shaped portion 140 of the torso support bladder 120. The horseshoe-shaped portion 140 increases the stability and comfort of the patient while contributing to the positioning of the patient for proper intubation. The horseshoe-shaped portion 140 of the torso support bladder 120 cradles the patient around the torso and buttocks thereby mitigating the rocking that would otherwise result from an inflatable bladder which did not contain the horseshoe-shaped portion 140. Additionally, a vacuum pump, or similar device, may be incorporated to actively assist in the deflation of the head support bladder 115, or the torso support bladder 120 (or both) to improve the functionality of the device. The addition of a vacuum pump, or similar device, improves both the sensitivity and the reliability of the associated controls. In one embodiment, both the compressor and the vacuum pump would be connected into the control box and the controllers would be able to activate both the compressor and the vacuum pump. The combination of both a compressor and a vacuum pump permits the operator to actively inflate and/or actively deflate either the torso support bladder 120 and/or the head support bladder 115. The addition of the vacuum pump increases the functionality of the device. Preferably, the vacuum pump would be a UL certified vacuum pump. For example, and without limitation, in one embodiment, moving the joystick in a northerly direction may engage the compressor to inflate the head support bladder 115, while moving the joystick in a southerly direction may engage the vacuum pump to deflate the head support bladder 115. Similarly, moving the joystick in an easterly direction, may engage the compressor to inflate the torso support bladder 120, while moving the single joystick in a westerly direction may engage the vacuum pump to deflate the torso support bladder 120.

Incorporated within torso support bladder 120 is a horseshoe shaped design 140 which assists in the proper positioning of the patient for endotracheal intubation As the torso support bladder 120 is inflated, compressed air is diverted into the internal horseshoe shaped component of the torso support bladder 120 to assist in properly positioning the patient for endotracheal intubation. If the patient is not in the proper position for endotracheal intubation, inflating the internal horseshoe shaped component included in the torso support bladder 120, will permit the patient to be move into an optimal/near optimal position as compressed air enters the internal horseshoe shaped component.

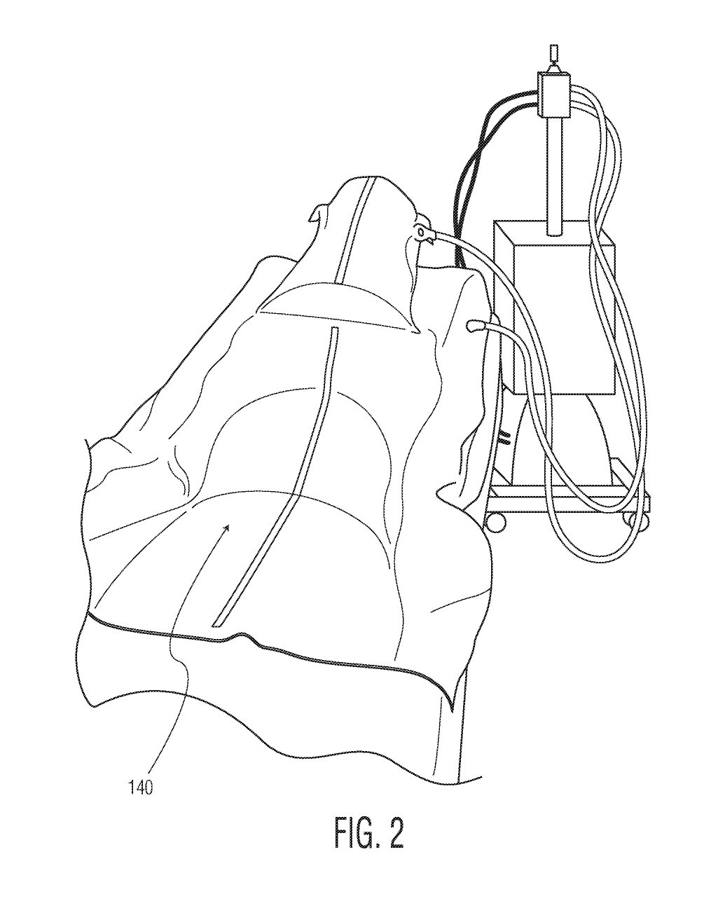

FIG. 2 illustrates another view of the improved active head/shoulder and torso positioning device 100 which provides a better view of the horseshoe-shaped component 140.

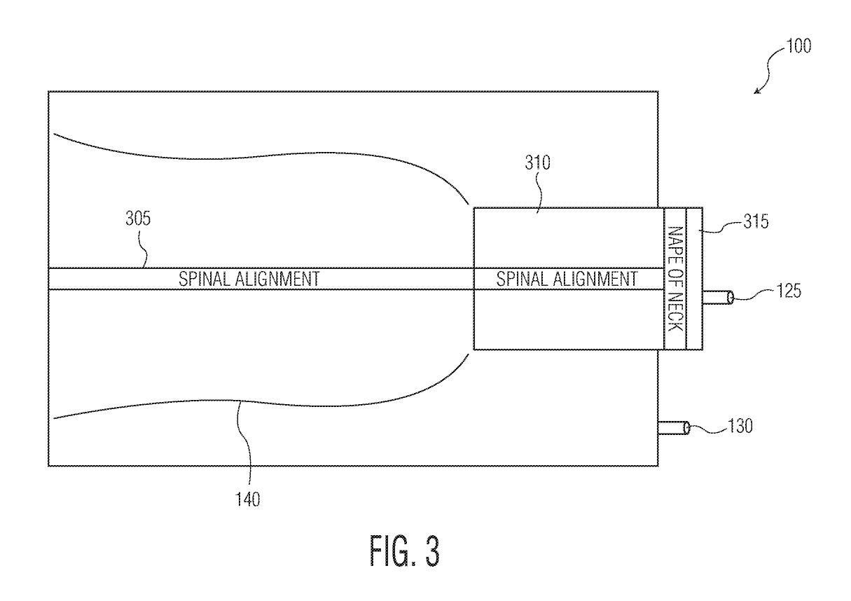

FIG. 3 illustrates a top view of the improved active head/shoulder and torso positioning device 100. The inflatable torso support bladder and the head support bladder both include a vertical marking for “Spinal Alignment” 305, 310 while the inflatable head support bladder includes a horizontal marking 315 for “Nape of Neck” alignment.

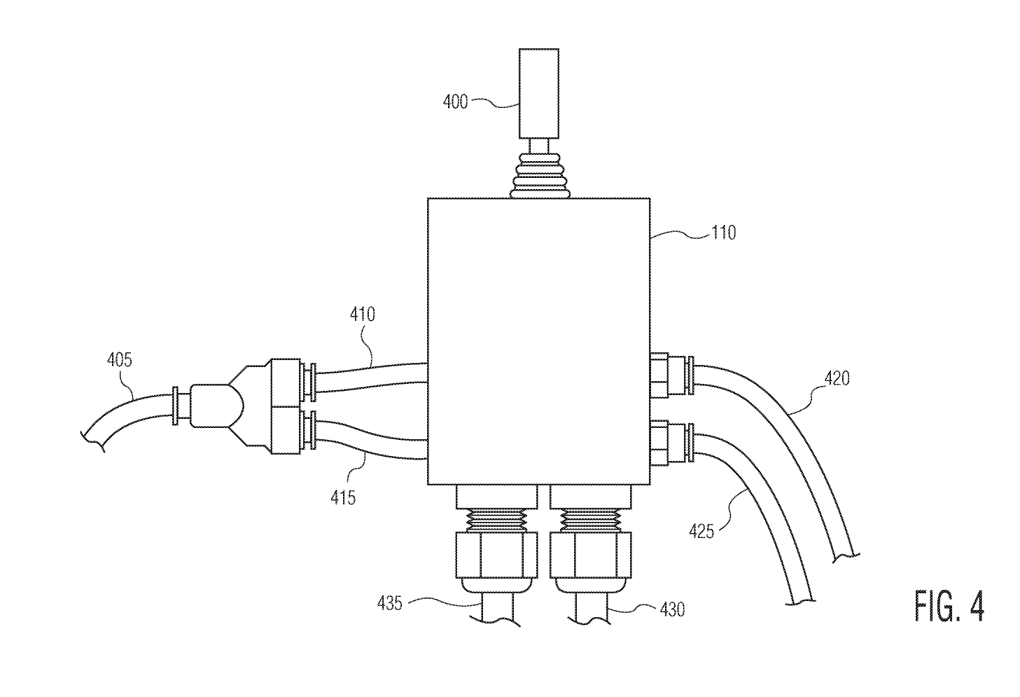

FIG. 4 shows a front view of the dual axis joystick/controller module 110. Shown on top of the dual axis joystick/controller module 110 is a joystick/controller 400. Compressed air from a compressor or other source of compressed air (not shown) enters from the left 405 and preferably is split into two sources 410, 415 of compressed area prior to its arrival at dual axis joystick/controller module 400. Dual axis joystick/module 400 provides two sources of controlled compressed air 420, 425. One source of controlled compressed air 420 is delivered to the head support bladder 115 while the second source of controlled compressed air 425 is delivered to the torso support bladder 120. The operator controls the amount of air which is directed to either the head support bladder 115 of the torso support bladder 120 through the joystick/controller 400. For example, and without limitation, moving the joystick/controller 400 in a northerly direction may inflate the head support bladder 115, while moving the joystick/controller 400 in a southerly direction may deflate the head support bladder 115. Similarly, moving the joystick/controller 400 in an easterly direction may inflate the torso support bladder 120 while moving the joystick/controller 400 in a westerly direction may deflate the torso support bladder 120. One of ordinary skill in the art would appreciate that other combinations between inflation and deflation of the head support bladder 115 and the torso support bladder 120 are possible for the joystick/controller 400. In addition, a vacuum pump (not shown) may also be attached to the joystick/controller 400 so that the vacuum pump may be used to actively deflate either the head support bladder 115 and/or the torso support bladder 120. In addition, using the joystick/controller 400 combinations of inflating and deflating the head support bladder 115 and torso support bladder 120 are possible. For example, in some embodiments moving the joystick/controller 400 in a north-easterly direction may cause inflation of both the head support bladder 115 and the torso support bladder 120. Similarly, moving the joystick/controller 400 in the south-westerly direction may cause deflation of both the head support bladder 115 and the torso support bladder 120. Movement of the joystick/controller 400 in a north-westerly direction may cause inflation of the head support bladder 115 and deflation of the torso support bladder 120. Movement of the joystick/controller 400 in a south-easterly direction may cause deflation of the head support bladder 115 and inflation of the torso support bladder 120. The addition of a vacuum pump increases the functionality of the improved head/shoulder and torso positioning device by permitting the active deflation of either (or both) of the bladders when the joystick/controller 400 is in the correct position. Again, one of ordinary skill in the art would appreciate that other combinations between movement of the joystick/controller 400 and inflation/deflation of the head support bladder 115 and the torso support bladder 120 are possible and within the scope of the invention. One of ordinary skill in the art would also appreciate that two sources of compressed gas could be fed into the combined joystick/controller thereby eliminating the need to split the air source into a first and second source of compressed air 410 and 415. FIG. 3 also shows the power cord 430 for the combined joystick/controller and relay 435. Relay 435 is connected to the pump and assists in turning the pump on and off. When the joystick/controller 400 is actuated, the pump turns on and when the joystick/controller is placed back in a neutral position, or in a position that enables deflating, the pump turns off.

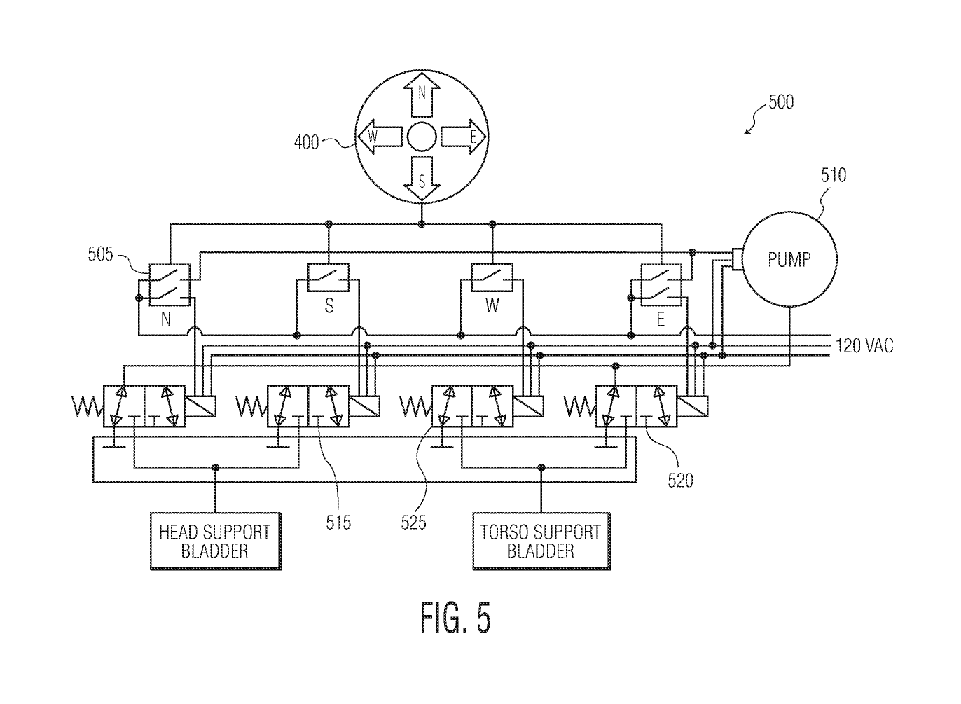

FIG. 5 illustrates the prototype schematic for the combined joystick/controller module 110. The joystick/controller 400 is connected to an electrical circuit 500 which controls one (or more) pumps and solenoids. When the joystick/controller 400 is in the neutral position, air is not directed into either the head support bladder 115 or the torso support bladder 120. When joystick/controller 400 is directed in a northerly direction, both solenoid 505 and pump 510 are engaged (or alternatively a source of compressed gas is enabled). When joystick/controller 400 is directed in a southerly direction, solenoid 515 is engaged, pump 510 is off, and head support bladder 115 is vented to atmosphere. When joystick/controller 400 is directed in an easterly direction, solenoid 520 is engaged, pump 510 is turned on, and torso support bladder 120 begins to inflate. When joystick/controller 400 is directed in a westerly direction, solenoid 525 is engaged, pump 510 is off, and air from torso support bladder is vented to atmosphere. When a vacuum is connected to the device, the vacuum can be used to actively deflate the head support bladder 115 and/or the torso support bladder 120 rather than venting the head support bladder 115 and/or the torso support bladder 120 to the atmosphere.

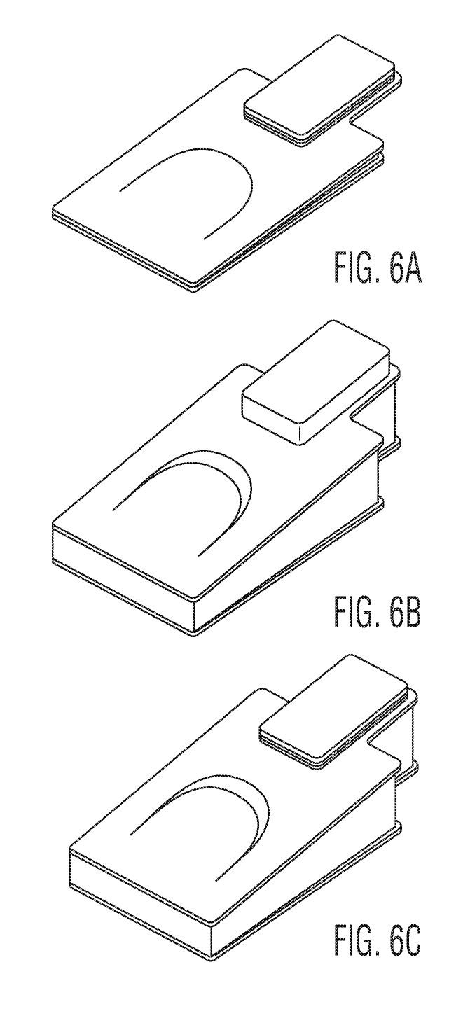

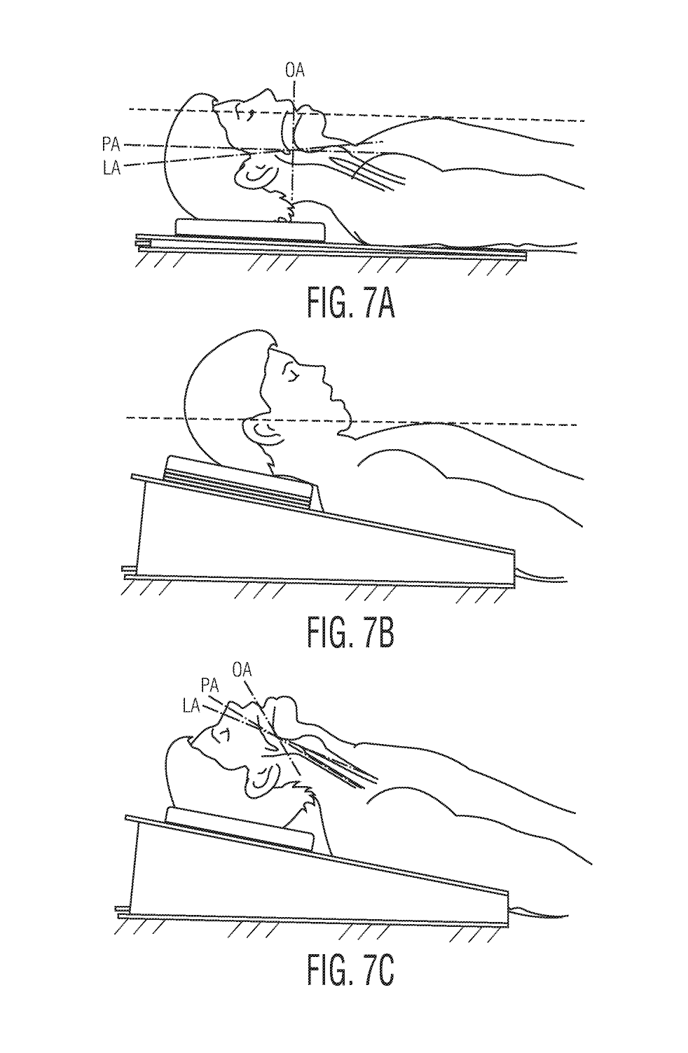

FIGS. 6A-6C show the improved active head/shoulder and neck positioning device in isolation in various stages of its inflation from the fully deflated position shown in FIG. 6A to a fully inflated position shown in FIG. 6C. Since the head support bladder 115 and the torso support bladder 120 can be individually controlled, it will be readily understood that any combination of headrest position and torso support position can be achieved. Since the movement of these two support bladders are controlled by air pressure, very small changes in either the head or the torso position can be achieved. Some of these positions are shown in FIGS. 7A-6C.

Referring now to FIG. 7A, the patient is shown reclining on an Improved Active Head/Torso Positioning Device for Endotracheal Intubation which is positioned behind the patient's upper torso with the head support bladder 115 underneath the back of the head. In this figure, both the main torso support bladder 120 and the head support bladder 115 are fully deflated. Line OA represents the oral axis, Line PA represents the pharyngeal axis, and Line LA depicts the laryngeal axis. This helps to achieve the aforementioned “sniffing position” necessary for most routine endotracheal intubations.

Referring now to FIG. 7B, when both the torso support bladder 120 and head support bladder 115 are expanded, the patient would be supported in this position. The horizontal dotted line is a reference point that is a rough approximation of the proper patient intubation position—the patient's ear should be approximately in alignment with the patient's chest. It can be seen that the patient's ear is at the proper level with respect to his chest, the neck is flexed and the head is tilted forward. Therefore, as in the case of FIG. 7A, the patient position shown in FIG. 7B may in some instances be adequate for endotracheal intubation.

Referring now to FIG. 7C, relative to FIG. 7B the head support bladder 115 has been partially deflated (or it has not been inflated). This causes the patient's head to tilt backward and places the three airway axes into closer alignment. These movements result in the desired sniffing position which can be obtained in concert with varying degrees of head elevation when difficult endotracheal intubation is encountered. Thus, by the three FIGS. 7A-7C, it has been demonstrated that the present support device may be utilized to achieve different patient body positions by independently controlling the amount of torso and head support. This is achieved by inflating or deflating the head support bladder 115 and the torso support bladder 120 as described with regard to FIGS. 6A-6C.

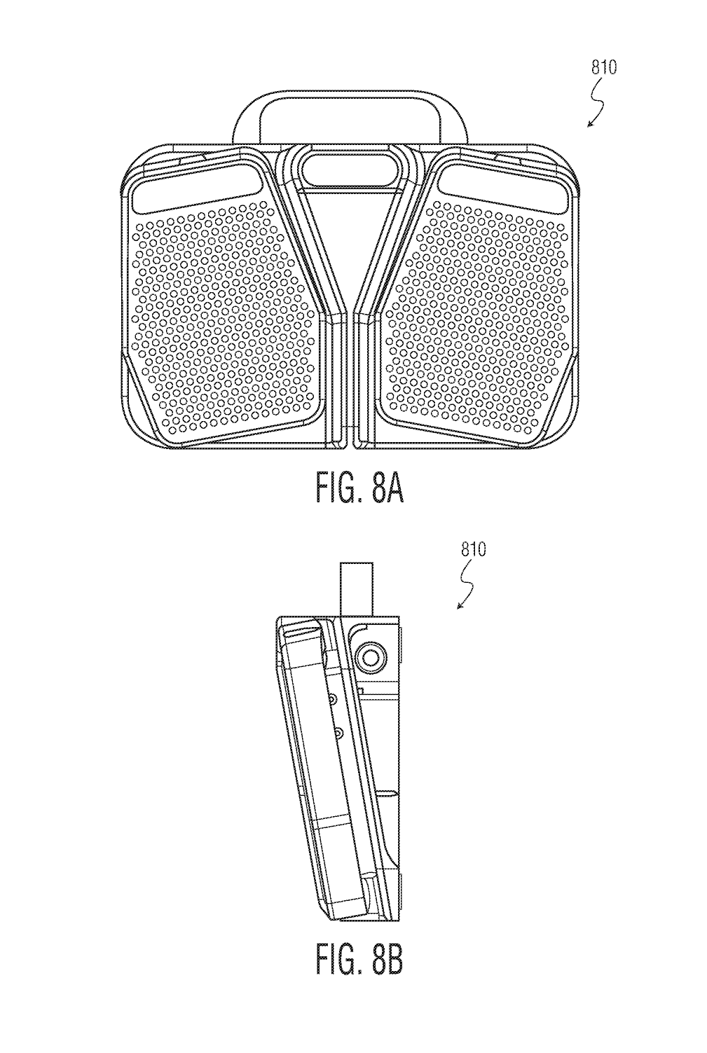

FIGS. 8A and 8B show a foot switch which may be used as a controller means for the improved active head/shoulder and neck positioning device. The foot switch may be used in place of the joystick, or in addition to the joystick depending on the configuration adopted.

It will therefore be understood that the present invention achieves all the desired objects and advantages of an active inflatable intubation patient support mat which can be used to position the patient's head and torso properly to facilitate intubation. More importantly, it may be finely controlled by the use of a combined joystick/controller so that changes in the body position can be made while the laryngoscopy procedure is carried out without the clinician's attention or visualization being diverted away from the patient. It will be understood that there will be other modifications that will be apparent to those of ordinary skill in the art, however these obvious variations will not represent a departure from the nature and spirit of the invention which should be determined only by the applicant's claims and their legal equivalents. For example, and without limitation, the source of compressed air (stand-alone pump or from a source of compressed air for the operating room) may be attached to a surgical boom which is used to supply compressed air to the head/shoulder and torso positioning device 100.

What is claimed is:

1. An improved active head/shoulder and neck positioning device for positioning a patient to undergo an endotracheal intubation, comprising:
a torso support bladder adapted to be positioned underneath the torso of a patient that may need to undergo endotracheal intubation whereby said torso support bladder expands as it is inflated and said torso support bladder can be vented to an atmosphere;
a head support bladder affixed to a top surface of said torso support bladder and positioned for placement beneath the patient's head, said head support bladder is operative to elevate the patient's head as the head support bladder is inflated and the headrest thereby expands;
at least one source of compressed air in fluid communication with said torso support bladder and said head support bladder; and
a combined joystick/controller means for selectively conducting pressurized air from said source to said torso support bladder and said head support bladder whereby the patient's torso/head position may be altered to achieve optimal anatomical alignment of the patient's larynx for intubation.

2. The improved active head/shoulder and neck positioning device of claim 1, wherein said torso support bladder includes an internal horseshoe-shaped chamber to provide added stability to the patient.

3. The improved active head/shoulder and neck positioning device of claim 2, wherein air directed into said torso support bladder is initially directed into said internal horseshoe shaped chamber.

4. The improved active head/shoulder and neck positioning device of claim 1, wherein the source of compressed air is a mechanical air compressor.

5. The improved active head/shoulder and neck positioning device of claim 1, wherein said combined joystick/controller means comprise four solenoids, each solenoid electrically connected to a direction of movement of a joystick.

6. The improved active head/shoulder and neck positioning device of claim 1, further including a vacuum pump for actively deflating at least one of said head support bladder or torso support bladder.

7. An improved active head/shoulder and neck positioning device for positioning a patient who may under an endotracheal intubation, comprising:
a torso support bladder adapted to be positioned underneath the torso of a patient that may need to undergo endotracheal intubation, where said torso support bladder including an internal chamber in the shape of a horseshoe configuration whereby said torso support bladder expands as it is inflated;
a head support bladder affixed to a top surface of said torso support bladder and positioned for placement beneath the patient's head, and said head support bladder is operative to elevate the patient's head as the head support bladder is inflated and the headrest thereby expands;
a source of compressed air in fluid communication with said torso support bladder and said head support bladder; and
a combined joystick/controller means for selectively conducting pressurized air from said source to said torso support bladder and said head support bladder whereby the patient's torso/head position may be altered to achieve optimal anatomical alignment of the patient's larynx for intubation.

8. The improved active head/shoulder and neck positioning device of claim 7, wherein air directed into said torso support bladder is initially directed into said internal horseshoe shaped chamber.

9. The improved active head/shoulder and neck positioning device of claim 7, wherein the source of compressed air is a mechanical air compressor.

10. The improved active head/shoulder and neck positioning device of claim 7, wherein said combined joystick/controller means comprise four solenoids, each solenoid electrically connected to a direction of movement of a joystick.

11. The improved active head/shoulder and neck positioning device of claim 7, further including a vacuum pump in fluid communication with said torso support bladder and said head support bladder used to actively deflate at least one of said head support bladder and torso support bladder.
